(19) United States
(12) Patent Application Publication
(10) Pub. No.: US 2023/0214647 A1
(43) Pub. Date: Jul. 6, 2023

(54) METHOD OF TRAINING SOUND RECOGNITION MODEL, METHOD OF RECOGNIZING SOUND, AND ELECTRONIC DEVICE FOR PERFORMING THE METHODS

(71) Applicant: Electronics and Telecommunications Research Institute, Daejeon (KR)

(72) Inventors: Soo Young PARK, Daejeon (KR); Tae Jin LEE, Daejeon (KR); Young Ho JEONG, Daejeon (KR)

(73) Assignee: Electronics and Telecommunications Research Institute, Daejeon (KR)

(21) Appl. No.: 17/869,242

(22) Filed: Jul. 20, 2022

(30) Foreign Application Priority Data
Jan. 6, 2022 (KR) 10-2022-0001963

(51) Int. Cl. G06N 3/08; G10L 25/51

(52) U.S. Cl. CPC G06N 3/08; G10L 25/51

(57) ABSTRACT

Provided are a method of recognizing sound, a method of training a sound recognition model, and an electronic device performing the same methods. A method of training a sound recognition model according to an example embodiment may include converting training data labeled with a sound class into a feature vector, storing the feature vector in a feature queue, transferring the feature vector stored in the feature queue to a block queue according to an operation of a feature vector transfer timer, inputting the feature vector of the block queue into a sound recognition model trained to predict the sound class and storing an output result in a result queue, transferring the feature vector stored in the feature queue corresponding to timing at which the result is output to the block queue by the feature vector transfer timer when the result is output.

### CROSS-REFERENCE TO RELATED APPLICATION

This application claims priority to Korean Patent Application No. 10-2022-0001963 filed on Jan. 6, 2022, in the Korean Intellectual Property Office, the entire disclosure of which is incorporated herein by reference for all purposes.

### BACKGROUND

### 1. Field of the Invention

One or more example embodiments relate to a method of training a sound recognition model, a method of recognizing sound, and an electronic device for performing the methods.

### 2. Description of the Related Art

Various techniques have been devised to improve performance of an artificial neural network-based system, and a model ensemble technique is being used in which several models obtained in a neural network training process are stored, inference results of respective stored models are obtained independently in an inference process, and the result are combined.

In the model ensemble technique, a complexity of the entire inference model increases by the number of the respective combined models, amounts of memory and computation required in the process of training the neural network models increase, and amounts of memory and computation required in the inference process using the trained neural network models increase.

### SUMMARY

The ensemble technique trains a plurality of neural network models, and requires high amounts of memory and computation by performing inference using the plurality of trained neural network models.

Example embodiments provide a method of recognizing sound, a method of training a sound recognition model, and an electronic device for performing the methods to which an ensemble method capable of improving the performance of a neural network model utilized in a sound recognition system for recognizing sound in real time is applied.

Example embodiments provide a method of recognizing sound which may be operated in a real-time operation process by performing ensemble computation using a single neural network model, a method of training a sound recognition model, and an electronic device for performing the methods.

Example embodiments provide a method of recognizing sound by which sound is recognized using a plurality of results output within a predetermined delay time of the neural network model for recognizing the sound, a method of training a sound recognition model, and an electronic device performing the methods.

According to an aspect, there is provided a method of training a sound recognition model including converting training data labeled with a sound class into a feature vector, storing the feature vector in a feature queue, transferring the feature vector stored in the feature queue to a block queue according to an operation of a feature vector transfer timer, inputting the feature vector of the block queue into a sound recognition model trained to predict the sound class and storing an output result in a result queue, transferring the feature vector stored in the feature queue corresponding to timing at which the result is output to the block queue by the feature vector transfer timer when the result is output, predicting the sound class using a plurality of the results stored in the result queue in consideration of a predetermined delay time, and training the sound recognition model using the predicted sound class and the labeled sound class.

The predicting of the sound class may include predicting the sound class by assigning a weight to each of the plurality of results according to time in which the plurality of results are included within the predetermined delay time.

The predicting of the sound class may include predicting the sound class using the predetermined delay time greater than a calculation time for outputting the result using the feature vector input to the sound recognition model.

The converting into the feature vector may include converting the training data into the feature vector according to a predetermined window size and hop size.

The sound recognition model may include a sound event recognition model configured to predict a sound event and a sound scene recognition model configured to predict a sound scene by inputting the training data including sound data labeled with the sound event and the sound scene.

According to another aspect, there is provided a method of recognizing sound may include converting sound data into a feature vector, storing the feature vector in a feature queue, transferring the feature queue to a block queue according to an operation of a feature vector transfer timer, inputting the feature vector of the block queue into a sound recognition model trained to predict a sound class of the sound data and storing an output result in a result queue, transferring the feature vector stored in the feature queue corresponding to timing at which the result is output to the block queue when the result is output, and predicting the sound class using a plurality of the results stored in the result queue in consideration of a predetermined delay time.

The predicting of the sound class may include predicting the sound class by assigning a weight to each of the plurality of results according to time in which the plurality of results are included within the predetermined delay time.

The predicting of the sound class may include predicting the sound class using the predetermined delay time greater than a calculation time for outputting the result using the feature vector input to the sound recognition model.

The converting into the feature vector may include converting the sound data into the feature vector according to a predetermined window size and hop size.

The sound recognition model may include a sound event recognition model trained to predict a sound event and a sound scene recognition model trained to predict a sound scene.

According to another aspect, there is provided an electronic device including a processor, the processor being configured to convert sound data into a feature vector, store the feature vector in a feature queue, transfer the feature queue to a block queue according to an operation of a feature vector transfer timer, input the feature vector of the block queue into a sound recognition model trained to predict a sound class of the sound data and storing an output result in a result queue, transfer the feature vector stored in the feature queue corresponding to timing at which the result is output to the block queue when the result is output, and predict the sound class using a plurality of the results stored in the result queue in consideration of a predetermined delay time.

The processor may be configured to predict the sound class by assigning a weight to each of the plurality of results according to time in which the plurality of results are included within the predetermined delay time.

The processor may be configured to predict the sound class using the predetermined delay time greater than a calculation time for outputting the result using the feature vector input to the sound recognition model.

The processor may be configured to convert the sound data into the feature vector according to a predetermined window size and hop size.

The processor may include a sound event recognition model trained to predict a sound event and a sound scene recognition model trained to predict a sound scene.

Additional aspects of example embodiments will be set forth in part in the description which follows and, in part, will be apparent from the description, or may be learned by practice of the disclosure.

According to example embodiments, it is possible to improve a neural network model by using an ensemble method through a single neural network model in a sound recognition system for recognizing sound in real time.

According to example embodiments, by using the ensemble method through the single neural network model, it is possible to reduce the amounts of memory and computation required for training the neural network model and inference using the trained neural network model compared to the ensemble method using a plurality of neural network models.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operation in which an electronic device recognizes a sound class of sound data according to an example embodiment;

FIG. 2 is a diagram illustrating a feature vector stored in a feature queue according to an example embodiment;

FIG. 3 is a diagram illustrating a plurality of results stored in a result queue according to an example embodiment;

FIG. 4 is a diagram illustrating a method of recognizing sound according to an example embodiment;

FIG. 5 is a diagram illustrating an operation in which an electronic device trains a sound recognition model according to an example embodiment; and

FIG. 6 is a diagram illustrating a method of training a sound recognition model according to an example embodiment.

### DETAILED DESCRIPTION

Hereinafter, example embodiments will be described in detail with reference to the accompanying drawings. However, it should be understood that these example embodiments are not construed as limited to the illustrated forms. Various modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular example embodiments only and is not to be limiting of the example embodiments. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

When describing the example embodiments with reference to the accompanying drawings, like reference numerals refer to like components and a repeated description related thereto will be omitted. When it is determined that specific descriptions of a well-known technology relating to the example embodiments may unnecessarily obscure the gist of the present disclosure, detailed descriptions thereof are omitted.

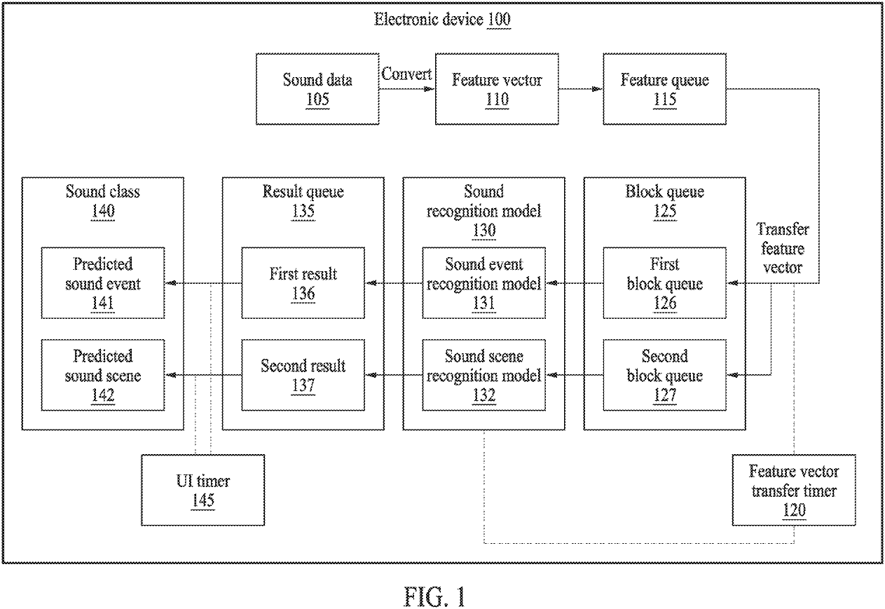

FIG. 1 is a diagram illustrating an operation in which an electronic device 100 recognizes a sound class 140 of sound data 105 according to an example embodiment.

Referring to FIG. 1, according to various example embodiments, the electronic device 100 may include the sound data 105, a feature queue 115, a feature vector transfer timer 120, a block queue 125, a sound recognition model 130, a result queue 135, or an UI timer 145. As an example, the electronic device may recognize the sound class 140 of the sound data 105 using a processor (not shown).

For example, the electronic device 100 may include a memory (not shown). For example, the memory may store the sound data 105, and may include the feature queue 115, the block queue 125, or the result queue 135. For example, the memory may include an internal memory or an external memory. For example, the memory may include a volatile memory or a non-volatile memory. For example, the sound data 105 may be stored in the non-volatile memory. The volatile memory may include the feature queue 115, the block queue 125, or the result queue 135. The volatile memory may store a feature vector 110 or a result stored in the feature queue 115, the block queue 125, or the result queue 135, respectively.

As an example, the electronic device 100 may convert the sound data 105 into the feature vector 110. The electronic device 100 may store the converted feature vector 110 in the feature queue 115.

For example, the electronic device 100 may store the sound data 105 into a wave buffer 150. The electronic device 100 may store the sound data 105 stored in the memory or the sound data 105 input in real time through a sound input device such as a microphone in the wave buffer 150.

The electronic device 100 may convert the sound data 105 stored in the wave buffer 150 into the feature vector 110 based on a window size and a hop size. For example, the window size may mean the length of the sound data 105 converted into the feature vector 110, and the hop size may mean the period of converting the sound data 105 into the feature vector 110.

For example, in the case of the window size of 40 msec and the hop size of 20 msec, the length of the sound data 105 converted into the feature vector 110 is 40 msec, which may be overlapped by 20 msec and converted into the feature vector 110.

As an example, the electronic device 100 may normalize the sound data 105 according to a predetermined window size and hop size using an input transfer timer 160, and transfer the normalized sound data 105 to the wave queue 155 (normalized wave queue). The electronic device 100 may convert the sound data 105 stored in the wave queue 155 into the feature vector 110, and store the feature vector 110 in the feature queue 115. For example, the input transfer timer 160 may transfer the sound data 105 having a length of 40 msec every 20 msec from the wave buffer 150 to the wave queue 155 according to the predetermined window size of 40 msec and the hop size of 20 msec.

As an example, using the sound data 105 stored in the wave queue 155, the electronic device 100 may execute a short time Fourier transform (STFT), a mel spectrogram transform, or a log mel transform to convert the sound data 105 into the feature vector 110.

According to various example embodiments, the electronic device 100 may transfer the feature vector 110 stored in the feature queue 115 to the block queue 125 according to an operation of the feature vector transfer timer 120. As an example, the electronic device 100 may transfer the feature vector 110 having a length corresponding to a predetermined delay time to the block queue 125.

For example, when the window size is 40 msec, the hop size is 20 msec, and the predetermined delay time is 1 sec, the electronic device 100 may transfer 50 feature vectors 110 to the block queue 125 according to the operation of the feature vector transfer timer 120. In the above example, the 50 feature vectors 110 transferred to the block queue 125 may have a length corresponding to the predetermined delay time of 1 sec in consideration of overlapping length.

As an example, the electronic device 100 may transfer the feature vector 110 to the block queue 125 based on when the feature vector transfer timer 120 operates. For example, the electronic device 100 may transfer the number of feature vectors 110 corresponding to the predetermined delay time to the block queue 125 based on when the feature vector transfer timer 120 operates.

According to various example embodiments, the electronic device 100 may input the feature vector 110 stored in the block queue 125 to the sound recognition model 130. For example, the sound recognition model 130 may be trained to predict the sound class 140 of the sound data 105. For example, the sound class 140 is a combination of an sound event that is an individual sound object that occurs and disappears at a specific time and individual sound objects that may occur at a specific location, and may include a sound scene representing spatial sound characteristics. The sound class 140 is not limited to the above sound event and/or sound scene, and various characteristics for distinguishing the sound data 105 may be applied.

According to various example embodiments, the electronic device 100 may store a result output from the sound recognition model 130 in the result queue 135. As an example, the output result may be data representing the sound class 140 of the sound data 105.

According to various example embodiments, the electronic device 100 may transfer the next feature vector 110 to the block queue 125 when a result is output from the sound recognition model 130. As an example, the feature vector transfer timer 120 of the electronic device 100 may transfer the feature vector 110 corresponding to timing at which the result is output from the sound recognition model 130 to the block queue 125. For example, the feature vector 110 corresponding to the timing at which the result is output may mean the feature vector 110 in the feature queue 115 before the predetermined delay time based on when the result is output from the sound recognition model 130.

For example, as in the above example, 50 feature vectors 110 from a feature vector 1 to a feature vector 50 may be input to the sound recognition model 130, and results may be output. After the feature vector 110 is input to the sound recognition model 130 and a time required for calculation has elapsed, a result may be output. For example, if the time required for the sound recognition model 130 to output a result is 0.2 sec, when the window size is 40 msec and the hop size is 20 msec, 10 new feature vectors 110, for example, a feature vector 51 to a feature vector 60 may be stored in the feature queue 115.

In the above example, the electronic device 100 may input the feature vector 1 to the feature vector 50 into the sound recognition model 130 and output the result after 0.2 sec. When the result is output, the feature vector transfer timer 120 may transfer a feature vector 11 to the feature vector 60 to the block queue 125 among the feature vector 1 to the feature vector 60 stored in the feature queue 115. For example, the feature vector 11 to the feature vector 60 may mean the feature vector 110 corresponding to the timing at which the result is output.

According to various example embodiments, the electronic device 100 may predict the sound class 140 by using a plurality of results stored in the result queue 135 in consideration of the predetermined delay time. As an example, the UI timer 145 of the electronic device 100 may calculate the sound class 140 for each predetermined delay time using a plurality of results output within each delay time.

For example, the electronic device 100 may store the plurality of results in the result queue 135. As an example, the electronic device 100 may repeatedly transfer the feature vector 110 to the block queue 125, input the feature vector 110 to the sound recognition model 130, and store the output result to the result queue 135.

For example, in the above example, the electronic device 100 may store a plurality of results, such as a result 1 output by inputting the feature vector 1 to the feature vector 50 to the sound recognition model 130, a result 2 output by inputting the feature vector 11 to the feature vector 60 to the sound recognition model 130, and a result 3 output by inputting a feature vector 21 to a feature vector 70 to the sound recognition model 130. The electronic device 100 may predict the sound class 140 of the sound data 105 by using the result stored in the result queue 135 within each delay time for each predetermined delay time.

For example, the electronic device 100 may calculate the sound class 140 by using the result 1 and the result 2 output from a voice recognition model within the predetermined delay time, and calculate the sound class 140 by using the result 3 and the result 4 output from the voice recognition model within the next delay time. For example, the electronic device 100 may calculate the sound class 140 by using the result output from the voice recognition model within each predetermined delay time.

As an example, the sound recognition model 130 may include an sound event recognition model 131 or an sound scene recognition model 132. For example, the sound event recognition model 131 may mean a neural network model trained to recognize the sound event included in the sound data 105, and the sound scene recognition model 132 may mean a neural network model trained to recognize the sound scene included in the sound data 105.

As an example, the block queue 125 may include a first block queue 126 or a second block queue 127. For example, the first block queue 126 may store the feature vectors 110 input to the sound event recognition model 131. For example, the second block queue 127 may store the feature vectors 110 input to the sound scene recognition model 132.

As an example, the feature vector transfer timer 120 may transfer the feature vector 110 stored in the feature queue 115 to the first block queue 126 or the second block queue 127. For example, the feature vector transfer timer 120 may transfer the feature vector 110 stored in the feature queue 115 to the first block queue 126 or the second block queue 127, or transfer the feature vector 110 after converting. For example, the feature vector transfer timer 120 may convert the feature vector 110 stored in the feature queue 115 into a matrix, and transfer the matrix to the first block queue 126 or the second block queue 127.

As an example, the electronic device 100 may input the feature vector 110 stored in the first block queue 126 or the second block queue 127, or the matrix converted from the feature vector 110 into the sound event recognition model 131 or the sound scene recognition model 132, respectively.

The sound event recognition model 131 outputs a first result 136 using the input feature vector 110 or the matrix converted from the feature vector 110, and the output first result 136 may be stored in the result queue 135. The sound scene recognition model 132 outputs a second result 137 using the input feature vector 110 or the matrix converted from the feature vector 110, and the output second result 137 may be stored in the result queue 135.

For example, when the first result 136 is output, the feature vector transfer timer 120 may transfer the feature vector 110 stored in the feature queue 115 to the first block queue 126. As an example, when the second result 137 is output, the feature vector transfer timer 120 may transfer the feature vector 110 stored in the feature queue 115 to the second block queue 127.

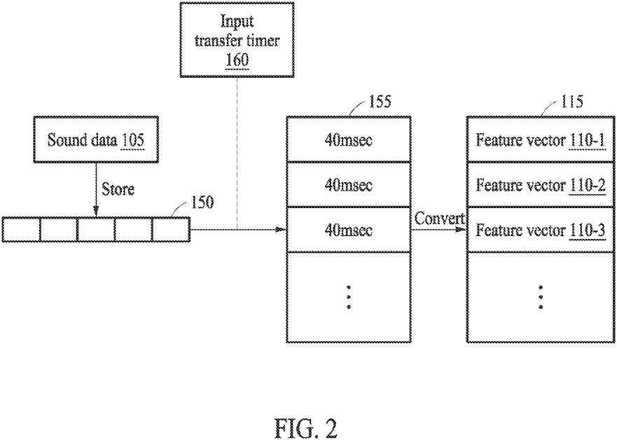

FIG. 2 is a diagram illustrating the feature vector 110 stored in the feature queue 115 according to an example embodiment.

Referring to FIG. 2, the electronic device 100 may store the sound data 105 into a wave vector 150. As an example, the sound data 105 may be input in real time from the sound input device of the electronic device 100 and stored in the wave vector. As an example, the sound data 105 may be the sound data 105 stored in the memory of the electronic device 100.

According to various example embodiments, the electronic device 100 may transfer the sound data 105 stored in the wave buffer 150 to the wave queue 155 according to the operation of the input transfer timer 160. As an example, the electronic device 100 may store the sound data 105 in the wave queue 155 based on the predetermined window size and hop size. For example, the input transfer timer 160 may transfer the sound data 105 corresponding to the window size for each hop size from the wave buffer 150 to the wave queue 155.

For example, when the window size set in FIG. 2 is 40 msec and the hop size is 20 msec, the electronic device 100 may transfer sound data 105 having a length of 40 msec to the wave queue 155 every 20 msec. The sound data 105 stored in the wave queue 155 may each have a length of 40 msec and overlapped by a length of 20 msec. For example, when comparing the sound data 105 stored at time T with the sound data 105 stored at time T+20 msec, the latter half 20 msec of the sound data 105 stored at the time T and the first half 20 msec of the sound data 105 stored at the time T+20 msec may be overlapped.

As an example, the electronic device 100 may normalize the sound data 105 stored in the wave buffer 150 and transfer the normalized sound data 105 to the wave queue 155.

According to various example embodiments, the electronic device 100 may convert the sound data 105 stored in the wave queue 155 into the feature vector 110, and store the feature vector 110 in the feature queue 115. For example, the electronic device 100 may execute the short time Fourier transform (STFT), the mel spectrogram transform, or the log mel transform for the sound data 105 to convert the sound data 105 into the feature vector 110.

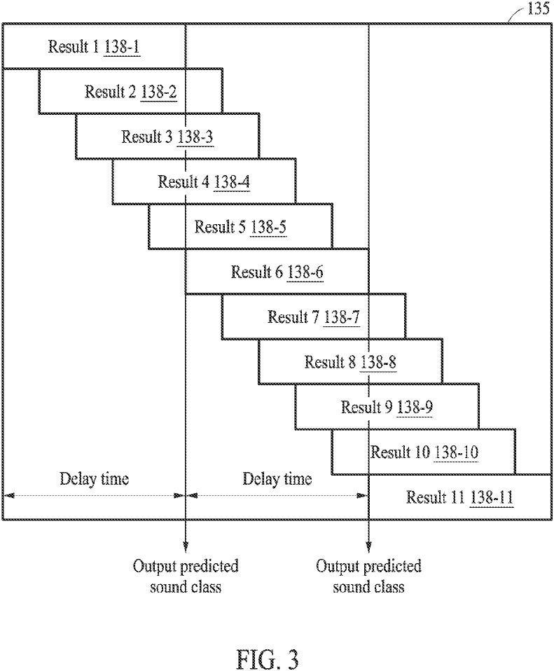

FIG. 3 is a diagram illustrating a plurality of results 138-1 to 138-11 stored in the result queue 135 according to an example embodiment.

FIG. 3 illustrates the plurality of results stored in the result queue 135 when the window size is 40 msec, the hop size is 20 msec, the delay time is 1 sec, and the calculation time of the sound recognition model 130 is 0.2 sec, among various example embodiments. The window size, the hop size, the delay time, or the calculation time of the sound recognition model 130 is not limited to the above example.

The results stored in the result queue 135 shown in FIG. 3 may mean, for example, results output from the sound recognition model 130. As another example, the results shown in FIG. 3 may be understood to represent the first result 136 output from the sound event recognition model 131 or the second result 137 output from the sound scene recognition model 132.

Referring to FIG. 3, the plurality of results may be stored in the result queue 135. For example, the result 1 138-1 may represent a result output by inputting the feature vector 1 to the feature vector 50 into the sound recognition model 130. For example, the result 2 138-2 may represent a result output by inputting the feature vector 11 to the feature vector 60 to the sound recognition model 130, and the result 3 138-3 may represent a result output by inputting the feature vector 21 to the feature vector 70 to the sound recognition model 130, and substantially the same description as above may be applied to the result 4 to a result 11 138-4 to 138-11. For example, the result 11 138-11 may represent a result output by inputting a feature vector 101 to a feature vector 150 into the sound recognition model 130.

Each of the results shown in FIG. 3 may mean that 50 feature vectors 110 are input and output to the sound recognition model 130. The number of feature vectors 110 input to the sound recognition model 130 may be based on the window size, the hop size, or the delay time. In the above example, considering the overlap length according to the window size and the hop size, the 50 feature vectors 110 may correspond to 1 sec of the sound data 105 and 1 sec of the delay time.

In FIG. 3, the start point of each result (e.g., the left end of the results 138-1 to 138-11 in FIG. 3) means timing at which the result is output and stored in the result queue 135, and the length of the result may correspond to the length of the input feature vector 110 to the sound data 105. For example, the result 1 138-1 may be output at 0 second and stored in the result queue 135, and the result 1 may be output using the feature vector 110 having a length of 1 sec. The result 2 138-2 may be output by inputting the feature vector 110 transferred to the block queue 125 to the sound recognition model 130 when the result 1 138-1 is output. For example, the result 2 138-2 may be stored in the result queue 135 at 0.2 sec after the calculation time of the sound recognition model 130 has elapsed from the timing at which the result 1 138-1 is output and stored in the result queue 135.

Referring to FIG. 3, according to various example embodiments, the electronic device 100 may predict the sound class 140 by using the plurality of results stored in the result queue 135 in consideration of the predetermined delay time.

As an example, the electronic device 100 may output the predicted sound class 140 using a plurality of results stored within the delay time. For example, the electronic device 100 may output the predicted sound class 1 using the result 1 138-1, the result 2 138-2, the result 3 138-3, the result 4 138-4 and the result 5 138-5. For example, the electronic device 100 may output the predicted sound class 2 by using the result 6 to the result 10 138-6 to 138-10.

As another example, the electronic device 100 may output the predicted sound class 140 using a plurality of results corresponding to the delay time. For example, the electronic device 100 may output the predicted sound class 2 by using the result 2 to the result 10 138-2 to 138-10. In the example above, the result 2 to the result 10 138-2 to 138-10 may correspond to the second delay time.

According to an example embodiment, the electronic device 100 may predict the sound class 140 by assigning a weight to each of the plurality of results according to time in which the plurality of results are included within the predetermined delay time. For example, the electronic device 100 may output the predicted sound class 1 by using a weighted average of the result 1 to the result 5 138-1 to 138-5. For example, because the result 1 138-1 is the longest in the delay time and the result 5 138-5 is the shortest in delay time, so the predicted sound class 1 may be obtained by giving high weights in the order of the result 1 138-1, the result 2 138-2, the result 3 138-3, the result 4 138-4, and the result 5 138-5. As another example, the electronic device 100 may output the predicted sound class 2 by using a weighted average of the result 2 to the result 10 138-2 to 138-10.

As an example, the predetermined delay time may be greater than the calculation time for inputting the feature vector 110 into the sound recognition model 130 and outputting the result. For example, the time taken from output of the result 1 to output of the result 2 in FIG. 3 may be the calculation time of the sound recognition model 130. If the delay time is greater than the calculation time, the plurality of results may be stored in the result queue 135 within the delay time.

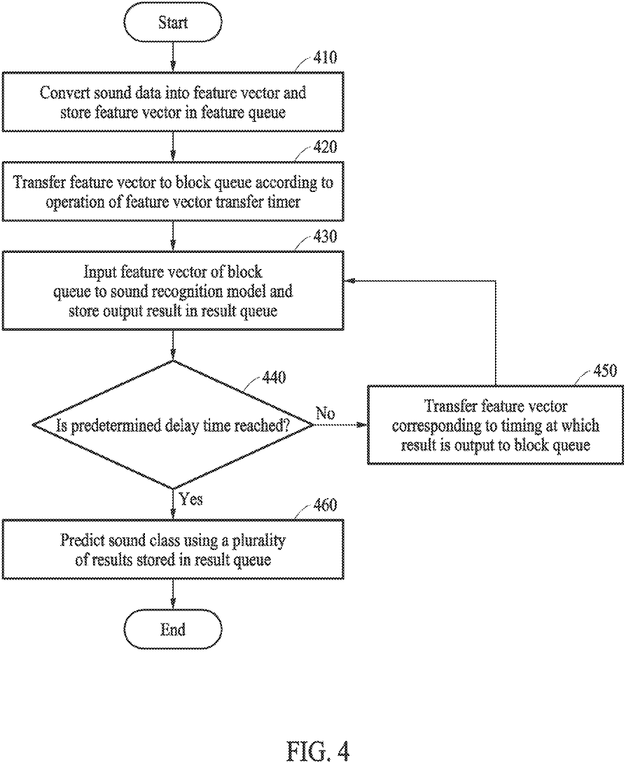

FIG. 4 is a diagram illustrating a method of recognizing sound according to an example embodiment.

Referring to FIG. 4, according to various example embodiments, the electronic device 100 may convert the sound data 105 to the feature vector 110 in operation 410, and store the converted feature vector 110 in the feature queue 115. As an example, the electronic device 100 may store input sound signal in the wave buffer 150, and transfer the sound data 105 to the wave queue 155 based on the window size and the hop size set according to the operation of the input transfer timer 160. The electronic device 100 may convert the sound data 105 stored in the wave queue 155 into the feature vector 110, and store the feature vector 110 in the feature queue 115.

In operation 420, according to various example embodiments, the electronic device 100 may transfer the feature vector 110 to the block queue 125 according to the operation of the feature vector transfer timer 120. The feature vector transfer timer 120 may transfer a plurality of feature vectors 110 corresponding to the predetermined delay time to the block queue 125 in consideration of the window size and the hop size.

According to various example embodiments, in operation 430, the electronic device 100 may input the feature vector 110 of the block queue 125 to the sound recognition model 130 and store the output result in the result queue 135. As an example, the sound recognition model 130 may include the sound event recognition model 131 and the sound scene recognition model 132. For example, in operation 420, the electronic device 100 may transfer the feature vector 110 to the first block queue 126 and/or the second block queue 127. In operation 430, the electronic device 100 may input the feature vector 110 stored in the first block queue 126 to the sound event recognition model 131 to output the first result 136, and input the feature vector 110 stored in the second block queue 127 to the sound recognition model 132 to output the second result 137.

According to various example embodiments, the electronic device 100 may determine whether to reach a predetermined delay time in operation 440.

According to various example embodiments, when not reaching the predetermined delay time in operation 440, the electronic device 100 may transfer the feature vector 110 corresponding to the timing at which the result is output to the block queue 125 in operation 450.

According to various example embodiments, when reaching the predetermined delay time in operation 440, the electronic device 100 may predict the sound class 140 using a plurality of results stored in the result queue 135 in operation 460.

According to an example embodiment, the method of recognizing sound shown in FIG. 4 illustrates an operation of predicting the sound class 140 when the delay time is reached. In an example embodiment different from the embodiment shown in FIG. 4, the method of recognizing sound may output a predicted sound class 140 for each delay time, and transfer the feature vector 110 corresponding to the timing at which the result is output to the block queue 125 whenever the result is output.

For example, when the predetermined delay time is reached, the electronic device 100 may predict the sound class 140 by using the plurality of results stored in the result queue 135. For example, the electronic device 100 may determine whether the input sound data 105 exists or whether the feature vector 110 corresponding to the timing at which the result is output exists in the feature queue 115.

For example, when the feature vector 110 corresponding to the timing at which the result is output does not exist, in other words, if there is no sound data 105 input in operation 410, or the converted feature vector 110 is not stored in the feature queue 115, the electronic device 100 may end the operation.

For example, when the feature vector 110 corresponding to the timing at which the result is output exists, the electronic device 100 may repeat operation 450, operation 430, and operation 440. When the next delay time is reached, the electronic device 100 may predict the sound class 140 by using the plurality of results stored in the result queue 135.

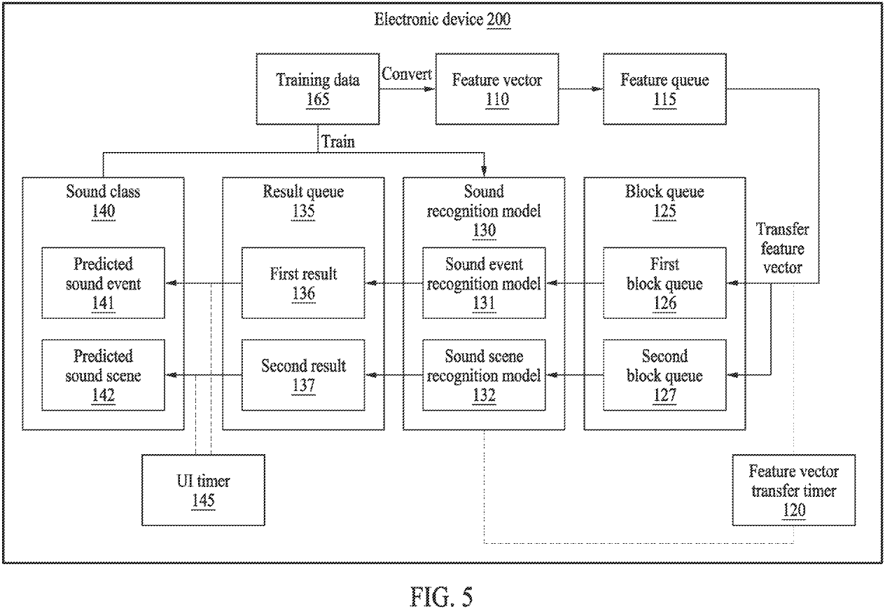

FIG. 5 is a diagram illustrating an operation of training a sound recognition model 130 by an electronic device 200 according to an example embodiment. The electronic device 200 shown in FIG. 5 may train the sound recognition model 130. For example, the sound recognition model 130 trained by the electronic device 200 shown in FIG. 5 may be the sound recognition model 130 shown in FIG. 1.

Referring to FIG. 5, according to various example embodiments, the electronic device 200 may include training data 165, the feature queue 115, the feature vector transfer timer 120, the block queue 125, the sound recognition model 130, the result queue 135 or the UI timer 145.

In the case of the feature queue 115, the feature vector transfer timer 120, the block queue 125, the sound recognition model 130, the result queue 135 or the UI timer 145 shown in FIG. 5, substantially the same description as the feature queue 115, the feature vector transfer timer 120, the block queue 125, the sound recognition model 130, the result queue 135 or the UI timer 145 may be applied.

As an example, the training data 165 may mean data for training the sound recognition model 130. For example, the training data 165 may include the sound data 105 labeled with the sound class. For example, the training data 165 may be labeled with the sound event that is an individual sound object that occurs and disappears at a specific time, or may be labeled with the sound scene that is a combination of individual sound objects that may occur at a specific location.

As an example, the electronic device 100 may convert the training data 165 to the feature vector 110, and store the feature vector 110 in the feature queue 115. The electronic device 100 may transfer the feature vector 110 stored in the feature queue 115 to the block queue 125 according to an operation of the feature vector transfer timer 120. The electronic device 100 may input the feature vector 110 stored in the block queue 125 into the sound recognition model 130, and store the output result in the result queue 135. The electronic device 100 may predict the sound class 140 by using a plurality of results stored in the result queue 135 in consideration of the predetermined delay time.

As an example, the electronic device 100 may train the sound recognition model 130 by using the predicted sound class 140 and the labeled sound class of the training data 165. For example, the electronic device 100 may obtain a loss function by comparing the predicted sound class 140 with the labeled sound class. The electronic device 100 may train the sound recognition model 130 to minimize the loss function.

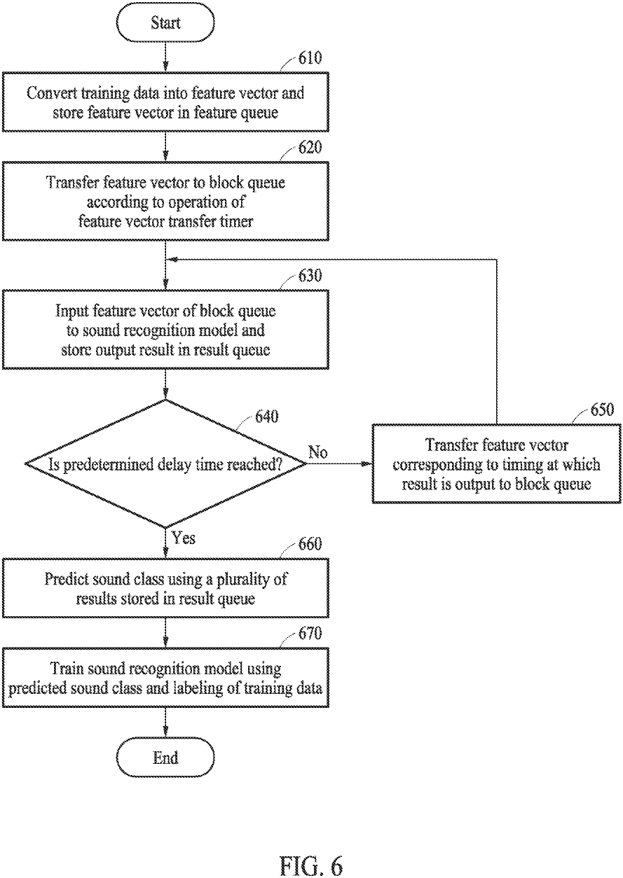

FIG. 6 is a diagram illustrating a method of training the sound recognition model 130 according to an example embodiment.

Referring to FIG. 6, according to an example embodiment, the electronic device 100 may convert the training data 165 to the feature vector 110, and store the feature vector 110 in the feature queue 115 in operation 610. The training data may include sound data 105 labeled with the sound class 140.

Operations 620, 630, 640, 650, or 660 shown in FIG. 6 may have substantially the same description as those of operations 420, 430, 440, and 450 shown in FIG. 4, respectively.

According to an example embodiment, the electronic device 100 may train the sound recognition model 130 by using predicted sound class 140 and labeling of the training data 165 in operation 670. For example, the electronic device 100 may obtain a loss function by comparing the predicted sound class 140 with the labeled sound class of the training data 165. The electronic device 100 may train the sound recognition model 130 to minimize the loss function.

The electronic device 100 and the method of recognizing sound described with reference to FIG. 1 to FIG. 4 above may recognize sound of the sound data 105 using the trained sound recognition model 130 according to the electronic device 100 and the method of training a sound recognition model described with reference to FIG. 5 and FIG. 6 above. Accordingly, even if the contents described with respect to FIG. 1 to FIG. 4 are not described with respect to FIG. 5 and FIG. 6, substantially the same configuration or operation may be applied.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The methods according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include all computer storage media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of training a sound recognition model, the method comprising:
converting training data labeled with a sound class into a feature vector;
storing the feature vector in a feature queue;
transferring the feature vector stored in the feature queue to a block queue according to an operation of a feature vector transfer timer;
inputting the feature vector of the block queue into a sound recognition model trained to predict the sound class and storing an output result in a result queue;
transferring the feature vector stored in the feature queue corresponding to timing at which the result is output to the block queue by the feature vector transfer timer when the result is output;
predicting the sound class using a plurality of the results stored in the result queue in consideration of a predetermined delay time; and
training the sound recognition model using the predicted sound class and the labeled sound class.

2. The method of claim 1, wherein the predicting of the sound class comprises predicting the sound class by assigning a weight to each of the plurality of results according to time in which the plurality of results are included within the predetermined delay time.

3. The method of claim 1, wherein the predicting of the sound class comprises predicting the sound class using the predetermined delay time greater than a calculation time for outputting the result using the feature vector input to the sound recognition model.

4. The method of claim 1, wherein the converting into the feature vector comprises converting the training data into the feature vector according to a predetermined window size and hop size.

5. The method of claim 1, wherein the sound recognition model comprises a sound event recognition model configured to predict a sound event and a sound scene recognition model configured to predict a sound scene by inputting the training data including sound data labeled with the sound event and the sound scene.

6. A method of recognizing sound, the method comprising:
converting sound data into a feature vector;
storing the feature vector in a feature queue;
transferring the feature vector stored in the feature queue to a block queue according to an operation of a feature vector transfer timer;
inputting the feature vector of the block queue into a sound recognition model trained to predict a sound class of the sound data and storing an output result in a result queue;
transferring the feature vector stored in the feature queue corresponding to timing at which the result is output to the block queue when the result is output; and
predicting the sound class using a plurality of the results stored in the result queue in consideration of a predetermined delay time.

7. The method of claim 6, wherein the predicting of the sound class comprises predicting the sound class by assigning a weight to each of the plurality of results according to time in which the plurality of results are included within the predetermined delay time.

8. The method of claim 6, wherein the predicting of the sound class comprises predicting the sound class using the predetermined delay time greater than a calculation time for outputting the result using the feature vector input to the sound recognition model.

9. The method of claim 6, wherein the converting into the feature vector comprises converting the sound data into the feature vector according to a predetermined window size and hop size.

10. The method of claim 6, wherein the sound recognition model comprises a sound event recognition model trained to predict a sound event and a sound scene recognition model trained to predict a sound scene.

11. An electronic device, comprising
a processor,
wherein the processor is configured to:
convert sound data into a feature vector, store the feature vector in a feature queue, transfer the feature vector stored in the feature queue to a block queue according to an operation of a feature vector transfer timer, input the feature vector of the block queue into a sound recognition model trained to predict a sound class of the sound data and storing an output result in a result queue, transfer the feature vector stored in the feature queue corresponding to timing at which the result is output to the block queue when the result is output, and predict the sound class using a plurality of the results stored in the result queue in consideration of a predetermined delay time.

12. The electronic device of claim 11, wherein the processor is configured to predict the sound class by assigning a weight to each of the plurality of results according to time in which the plurality of results are included within the predetermined delay time.

13. The electronic device of claim 11, wherein the processor is configured to predict the sound class using the predetermined delay time greater than a calculation time for outputting the result using the feature vector input to the sound recognition model.

14. The electronic device of claim 11, wherein the processor is configured to convert the sound data into the feature vector according to a predetermined window size and hop size.

15. The electronic device of claim 11, wherein the processor comprises a sound event recognition model trained to predict a sound event and a sound scene recognition model trained to predict a sound scene.
